(19) United States
(12) Patent Application Publication
(10) Pub. No.: US 2003/0133261 A1
(43) Pub. Date: Jul. 17, 2003

(54) Electronic device having switch operated by rotatable display

(75) Inventors: Hiroyuki Minaguchi, Saitama-ken (JP); Nobuyasu Tajima, Tokyo (JP); Koji Abe, Tokyo (JP); Takahuki Arisaka, Tokyo (JP)

Correspondence Address: FOLEY & LARDNER, 2029 CENTURY PARK EAST, SUITE 3500, LOS ANGELES, CA, 90067

(73) Assignee: KABUSHIKI KAISHA TOSHIBA

(21) Appl. No.: 10/326,506

(22) Filed: Dec. 19, 2002

(30) Foreign Application Priority Data
Jan. 16, 2002 (JP) JP2002-007748

(51) Int. Cl. G06F 1/16; H01H 3/16

(52) U.S. Cl. 361/681; 361/683; 200/61.58 R; 200/61.73

(57) ABSTRACT

An electronic device comprises a body having a raised portion. Switching means are mounted inside of the raised portion. The switching means perform a function and are provided within the raised portion such that the function is performed by moving the display between opened and closed positions. The switching means may include a switch for performing a function and a detecting member for operating the switch. The detecting member is movable between an extended position projecting from the raised portion and a retracted position within the raised portion. The electronic device further comprises a display rotatable between an opened position and a closed position. The switching means are arranged within the raised portion such that when the display is rotated between the opened position and the closed position, the detecting member moves between the extended and retracted positions, thus deactivating and activating the switch.

### RELATED APPLICATIONS

This application is based upon and claims the benefit of priority from prior Japanese Patent Application No. 2002-7748, filed Jan. 16, 2002, the entire contents of which are incorporated herein by reference.

### BACKGROUND OF THE INVENTION

1. Field of the Invention

The present invention relates to an electronic device such as a notebook type portable personal computer, particularly to an arrangement and structure of switching means for performing a function such as switching on and off a power source of a Liquid Crystal Display (“LCD”) panel.

2. Description of the Related Art

In recent years, various kinds of portable electronic devices having high functionality and portability have been introduced, for example notebook type portable computers. The portable electronic devices typically include a body having an input unit such as a keyboard etc., and a display such as an LCD panel. The display is typically rotatably supported by the body.

The body may have a switch for detecting whether the display is opened or closed. The power source of the display is turned off by means of the switch to save electricity when the display is rotated from an opened position to a closed position.

U.S. Pat. No. 6,191,938 discloses such an electronic device including a body having a switch and a display having a projecting portion for activating the switch. The switch is contained within the body of the electronic device. An upper surface of the body has an opening for exposing the switch. When the display is closed, a projecting portion of the display is inserted into the opening and activates the switch.

As described in the patent, the body contains a main printed circuit board (“PCB”) and a sub PCB. The switch is mounted on the sub PCB. Accordingly, the thickness of the body is increased. Furthermore, because the switch is contained in the body, it is difficult to freely design the arrangement and structure of the switch because of space constraints within the body of the device.

### BRIEF SUMMARY OF THE INVENTION

Embodiments of the present invention provide an electronic device having an arrangement and structure of switching means for activating a function of the electronic device, for example switching the electronic device (or components thereof) on and off, activating a power-save mode, and the like. Embodiments of the present invention allow for a reduced thickness of the body of the electronic device and increased freedom in designing the arrangement and structure of the switching means.

According to embodiments of the present invention, there is provided an electronic device comprising a display and a body having a raised portion for rotatably supporting the display. Switching means are provided for performing a function of the electronic device. The switching means are provided within the raised portion such that the function is performed by moving the display between opened and closed positions.

Embodiments of the invention provide a switching means including a mechanical switch, a detecting member movable between a retracted position within the raised portion and an extended position projecting outside of the raised portion that is movable for operating the mechanical switch, a supporting body for supporting the detecting member having a side surface, and a spring member having a first end fixed to the supporting body and a second end elastically movable between a first position contacting the side surface of the supporting body and a second position contacting the mechanical switch. The second end of the spring member is moved from the first position to the second position by the detecting member when the detecting member is moved from the extended position to the retracted position.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a notebook type personal computer, according to embodiments of the invention;

FIG. 2 is an enlarged perspective view showing switching means of the portable computer of FIG. 1, according to embodiments of the invention;

FIG. 3 is a detailed perspective view showing switching means, according to embodiments of the invention;

FIG. 4A is a perspective view showing a detecting member of the switching means in a extended position, according to embodiments of the invention;

FIG. 4B is a perspective view showing the same portion of the portable computer shown in FIG. 4A from a different angle;

FIG. 5A is a plan view showing the detecting member in an extended position, according to embodiments of the invention;

FIG. 5B is a plan view showing the detecting member in a retracted position, according to embodiments of the invention;

FIG. 6 is a perspective view showing the detecting member in an extended position, according to embodiments of the invention;

FIGS. 7A, 7B and 7C are simplified rear views of portable computers showing possible configurations of the raised portion.

### DETAILED DESCRIPTION OF THE INVENTION

Embodiments of the present invention will now be described with reference to drawings illustrating the present invention as applied to portable computers.

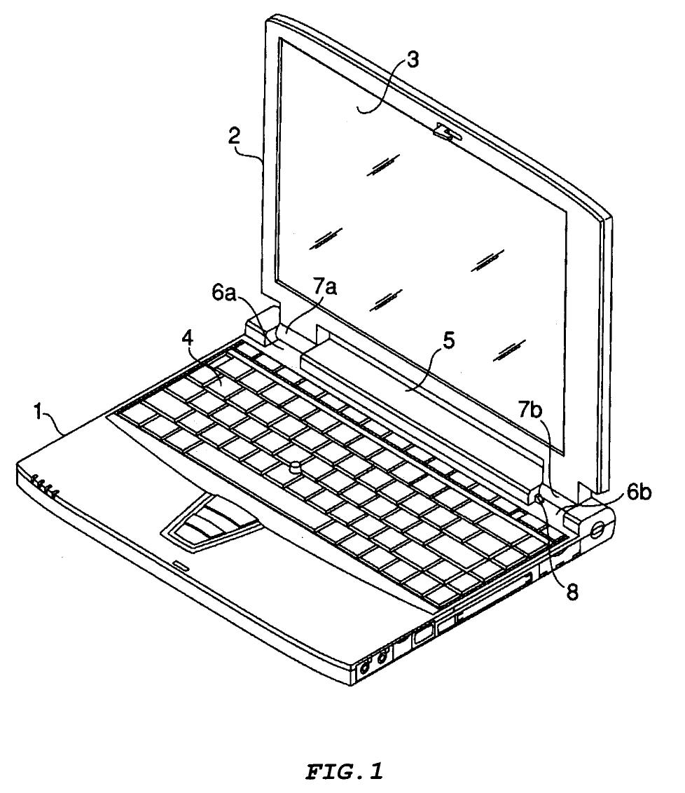

FIG. 1 is a perspective view showing a notebook type personal computer according to a first embodiment of the present invention. The computer has a body 1 and a display 2 supported rotatably by the body 1. The display 2 provides a LCD panel 3 therein. The body 1 has a keyboard 4 on an upper surface. The body 1 contains a printed circuit board and the like inside (not shown). The body 1 has a raised portion 5 projecting upward at a rear side of the upper surface.

The raised portion 5 may house a display element such as an LED. The raised portion 5 may also house other components of the electronic device such as a Universal Serial Bus (“USB”) connector, a printer connector, a power connector and the like. The raised portion 5 has a pair of recesses 6a and 6b of a predetermined width that divide the raised portion 5 into three sections. The pair of recesses 6a and 6b are mountable by a pair of connecting members such as leg portions 7a and 7b, provided at lower ends of the display 2, respectively. A hinge device (not shown) is provided between the leg portion 7a and the raised portion 5. Similarly, a hinge device (not shown) is provided between the leg portion 7b and the raised portion 5. Thus, the body 1 rotatably supports the display 2. By means of the hinge devices, the display 2 is rotatable and rotates about the body 1 between a closed position covering the keyboard 4 and an opened position exposing the keyboard 4.

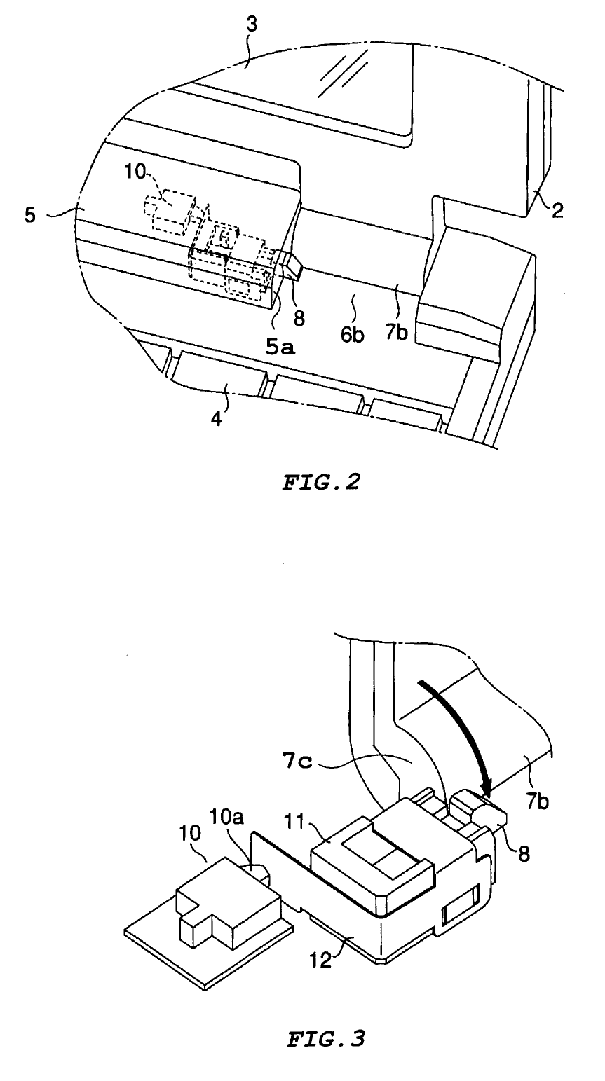

FIG. 2 is an enlarged perspective view showing switching means of the portable computer shown in FIG. 1, according to an embodiment of the present invention. The switching means includes a detecting member 8 and a switch 10. The dashed lines in FIG. 2 indicate portions of the switching means that are located inside the raised portion 5. The only portion of the switching means that is shown outside of the raised portion 5 in FIG. 2 is a tip portion of detecting member 8. FIG. 3 is a perspective view showing the switching means shown in FIG. 2 in detail.

The detecting member 8 is movable in a horizontal direction between an extended position wherein the tip portion thereof projects into the recess 6b from a side surface 5a of the raised portion 5, and a retracted position where the tip portion is retracted into the raised portion 5. When the display 2 is in an opened position, the tip portion of the detecting member 8 projects from the side surface 5a of the raised portion 5 into the recess 6b where leg portion 7b is inserted when the display 2 is in the closed position. When the display 2 is in a closed position, the tip portion of the detecting member 8 is retracted into the raised portion 5 by contacting leg portion 7b as it is inserted into recess 6b as the display 2 is closed. An upper portion of the detecting member 8 has a tapered surface that contacts leg portion 7b of the display 2 as it is closed. Thus, the detecting member 8 extends and retracts in parallel to a rear side of the body 1.

The function of detecting member 8 is to activate switch 10 to perform a function. The switch 10 is provided inside the raised portion 5. In one embodiment, switch 10 is a normally closed switch. As shown in FIG. 3, the switch 10 has an actuator 10a projecting in the same direction as detecting member 8. The actuator 10a activates and deactivates switch 10 and switch 10 performs a function. For example, when actuator 10a moves in a direction towards switch 10, it activates (opens) switch 10 and turns off the power source. Conversely, when actuator 10a moves in a direction away from switch 10, it deactivates (closes) switch 10 and turns on the power source of the display.

In the embodiment shown in FIGS. 2 and 3, the function of switch 10 is to switch on and off the power source of the LCD panel 3 attached at the display 2. However, in other embodiments of the present invention, switch 10 may be used to activate other functions such as, but not limited to, switching on and off other power sources or other components of the electronic device, activating a power save mode and the like. Similarly, although in the example embodiment shown in FIGS. 2 and 3 the tip portion of the detecting member 8 extends from a particular point in the side surface 5a of raised portion 5, the tip portion may extend from any suitable point on the side surface 5a of the raised portion 5. Furthermore, the tip portion of the detecting member 8 may extend from any suitable point on any of the side surfaces of recesses 6a and 6b that enables it to retract when contacting a leg portion of the display 2 as the display 2 is closed.

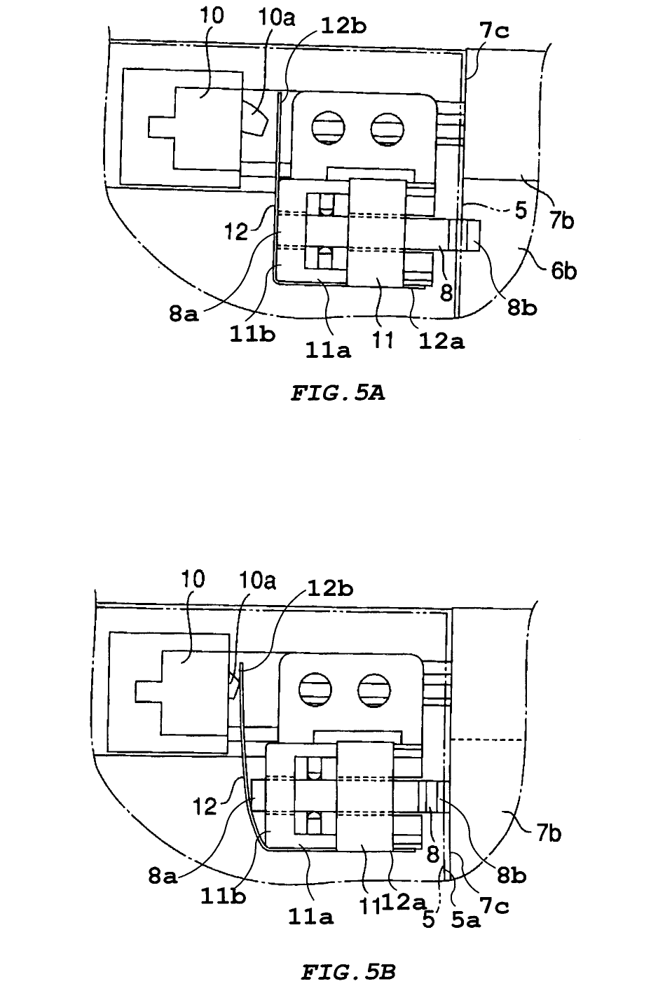

A supporting body 11 supports an intermediate portion and a rear end 8a (see FIG. 5B) of the detecting member 8 for movement in the horizontal direction. One end 12a (see FIG. 5B) of a spring member 12 is fixed to the front surface of the supporting body 11. The spring member 12 is an elastic plate formed by a spring material and is provided from front surface 11a to rear end 11b of the supporting body 11. Although end 12a is fixed to the supporting body 11, the other end 12b of the spring member 12 is not fixed to the supporting body 11, but instead is in elastic contact with it. The end 12b of the spring member 12 elastically contacts the rear end 8a of the detecting member 8 such that the detecting member 8 projects into the recess 6b from the side surface 5a of the raised portion 5. The end 12b may be elastically pushed away from the supporting body 11 by rear end 8a under sufficient force.

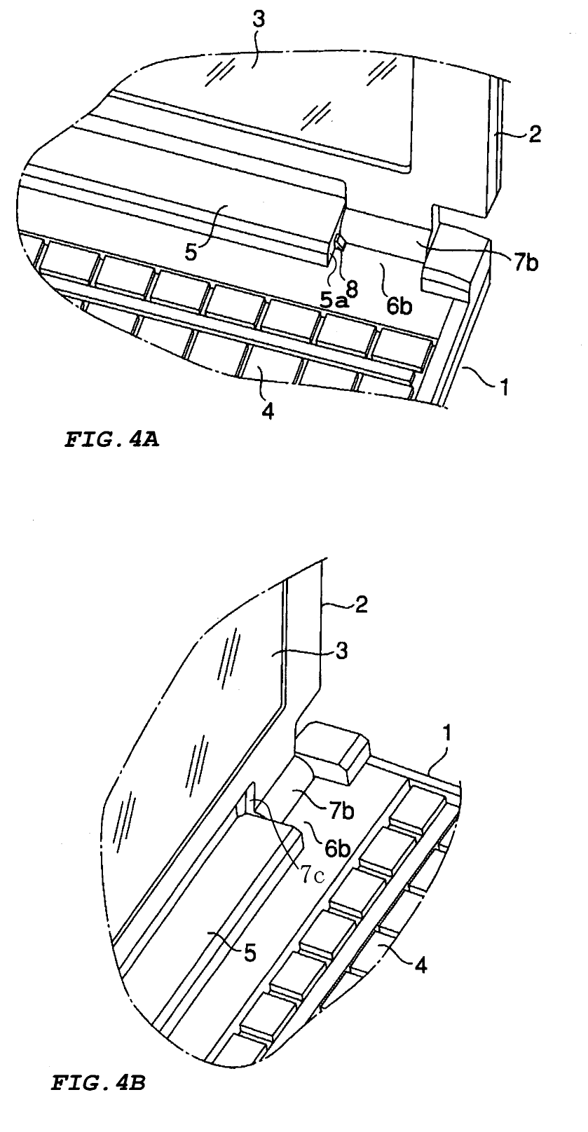

FIG. 4A is a another perspective view showing the detecting member 8 in an extended position within recess 6b. FIG. 4B is a perspective view showing the same portion of the portable computer from a different angle. As can be seen from FIGS. 4A and 4B, the tip portion of the detecting member 8 extends only slightly into the recess 6b. Therefore, accidental contact with the detecting member 8 is minimized. Consequently, inadvertent operation of the switch 10 is advantageously decreased and the reliability of the switch 10 is improved.

FIG. 5A is a plan view showing the detecting member 8 in an extended position. FIG. 5B is a plan view showing the detecting member 8 in a retracted position. As can be seen from FIG. 5A, when the display 2 is in the opened position, the end 12b of the spring member 12 directly contacts the rear end 11b of the supporting body 11 and also contacts the rear end 8a of the detecting member 8. Thus, the end 12b is separated from the actuator 10a of the switch 10 and the switch is deactivated. The leg portion 7b is currently positioned outside of recess 6b and thus does not contact detecting member 8.

As shown in FIG. 5B, by rotating the display 2 from an opened position to a closed position, the leg portion 7b of the display 2 rotates into the recess 6b. The side portion 7c of the leg portion 7b contacts the tip portion of the detecting member 8 that is extended into the recess 6b. Because the tip portion of the detecting member 8 is formed in a tapered shape at an upper surface thereof, side portion 7c of the leg portion 7b slides smoothly on a tapered surface 8b of the detecting member 8.

As a result, the detecting member 8 moves in a horizontal direction against the elastic force of the spring member 12 and the rear end 8a of the detecting member 8 extends from the supporting body 11 and presses free end 12b of the spring member 12 such that it deforms elastically in the direction of actuator 10a of the switch 10. The deformed spring member 12 contacts the actuator 10a, and moves the actuator 10a in a horizontal direction towards switch 10. Thus, switch 10 is activated and the power source of the LCD panel 3 of the display 2 is switched off.

When the display is again opened, the leg portion 7b moves away from recess 6b and no longer contacts the tip portion of the detecting member 8. The elastic force of the spring member 12 causes it to return to its original position contacting the rear end 11b of the supporting body 11. The rear end 8a of detecting member 8 is pushed by the spring member 12 and the tip portion of detecting member 8 again extends into the recess 6b. The end 12b is again separated from the actuator 10a of the switch 10, causing the switch to be deactivated, and the power source of the LCD panel 3 of the display 2 is switched on.

Because the detecting member 8 and the actuator 10a move in a horizontal direction at right angles to the rotating direction of the display 2, the switching means advantageously does not require that the height of the raised portion 5 be increased. Additionally, because the switching means is arranged in the already existing raised portion 5, an increase in the thickness of the body 1 of the electronic device is not required to accommodate the switching means.

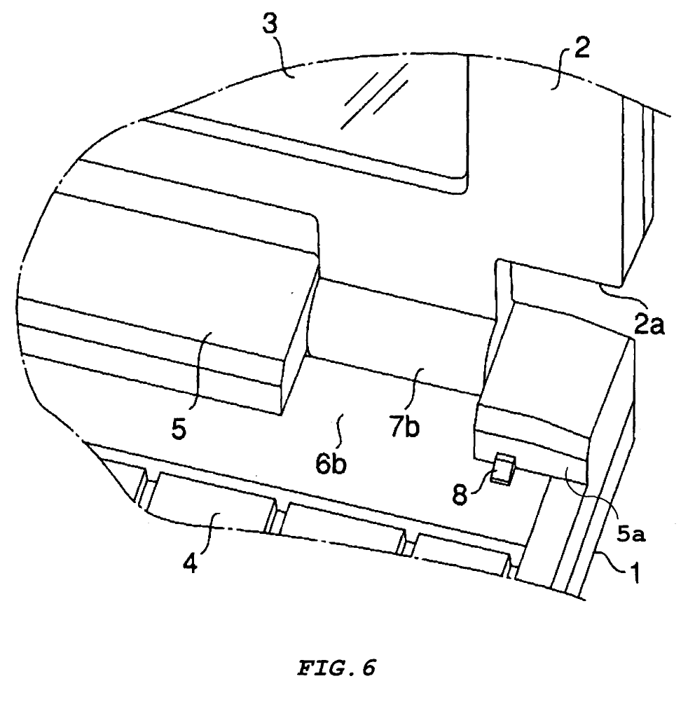

FIG. 6 is a perspective view showing a notebook type personal computer according to a second embodiment of the present invention. The second embodiment differs from the first embodiment in the placement of the switching means. As seen in FIG. 6, in the second embodiment the tip portion of the detecting member 8 (shown in an extended position) extends from a front surface 5b of the raised portion 5. As in the first embodiment, the remainder of the switching means is mounted inside the raised portion.

In the second embodiment, the switching means is positioned such that the detecting member 8 is movable at right angles to its movement in the first embodiment. Thus, while in the first embodiment detecting member 8 extends and retracts in parallel to a rear side of the body 1, in the second embodiment detecting member 8 extends and retracts in parallel to a lateral side of the body 1. The detecting member 8 moves between an extended position projecting from the front surface 5b of the raised portion 5 and a retracted position within the raised portion 5. As in the first embodiment, the function of detecting member 8 is to activate and deactivate switch 10.

In the second embodiment, the operation of the switching means is identical to that of the first embodiment. However, the manner of operating the switch in the second embodiment is different. More specifically, in the first embodiment, the tip portion of the detecting member 8 is retracted into the raised portion 5 by contacting leg portion 7b when it enters into recess 6b as the display 2 is closed. In contrast, in the second embodiment, the tip portion of the detecting member 8 is retracted into the raised portion 5 by contacting a portion, for example a back edge 2a, of the display 2 as the display 2 is closed. Although in the second embodiment, as shown in FIG. 6, the tip portion of the detecting member 8 extends from a particular point on the front surface 5b of raised portion 5, the tip portion may extend from any suitable point on the front surface 5b of the raised portion 5 that enables it to retract when contacting a portion of the display 2 as the display 2 is closed.

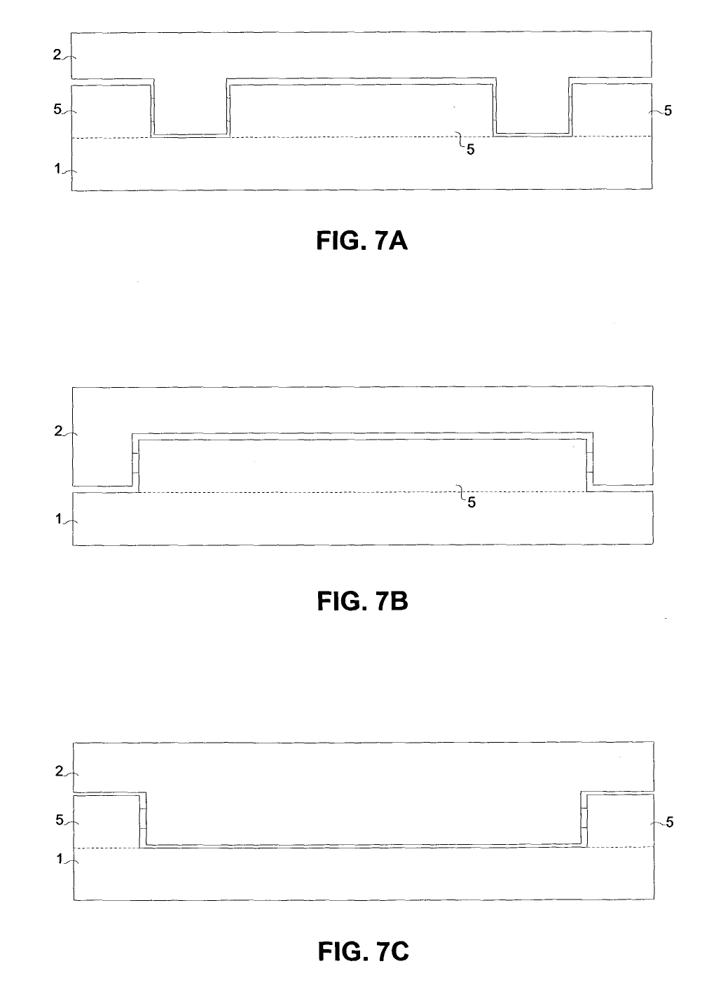

It is to be understood that although a portable notebook type personal computer having a particularly configured raised portion is described herein, embodiments of the present invention may be employed with electronic devices having other configurations of the raised portion. For example, FIGS. 7A, 7B and 7C illustrate a few of the possible raised portion configurations with which embodiments of the present invention may be employed. FIGS. 7A, 7B and 7C show simplified rear views of portable computers with their rotatable displays in the closed position. Each of the portable computers has a body 1, a display 2 and raised portions 5.

It is also to be understood that even though numerous characteristics and advantages of various embodiments of the present invention have been set forth in the foregoing description, together with details of the structure and function of various embodiments of the invention, this disclosure is illustrative only. Changes may be made in detail, especially matters of structure and management of parts within the principles of the present invention to the full extent indicated by the broad general meaning of the terms in which the appended claims are expressed.

For example, embodiments of the present invention are not limited to a mechanical switch with a movable detecting member as described herein, but may be implemented using different types of switches such as, but not limited to, solid state switches, light and dark activated switches, capacitance proximity switches, and the like. The modifications that may be necessary to implement embodiments of the present invention using such switches are within the knowledge of a person skilled in the art and are, therefore, not described further herein.

Furthermore, embodiments of the present invention are described herein with reference to a portable computer having a body and a rotatable display. However, embodiments of the present invention may be employed with a variety of electronic devices such as, but not limited to, mobile phones, personal digital assistants, mobile information terminals, game devices, car navigation devices, and the like.

Having disclosed exemplary embodiments and the best mode, modifications and variations may be made to the disclosed embodiments while remaining within the scope of the invention as defined by the following claims.

What is claimed is:

1. An electronic device comprising:
a display;
a body having a raised portion for rotatably supporting the display; and
switching means for performing a function, the switching means provided within the raised portion such that the function is performed by moving the display between opened and closed positions.

2. The electronic device recited in claim 1, wherein the switching means comprises a mechanical switch.

3. The electronic device recited in claim 2, wherein the switching means further comprises a detecting member movable between a retracted position within the raised portion and an extended position projecting outside of the raised portion, the detecting member movable for operating the mechanical switch.

4. The electronic device recited in claim 3, wherein the switching means further comprises:
a supporting body for supporting the detecting member, the supporting body having a side surface; and
a spring member having a first end fixed to the supporting body and a second end elastically movable between a first position contacting the side surface of the supporting body and a second position contacting the mechanical switch, the second end of the spring member being moved from the first position to the second position by the detecting member when the detecting member is moved from the extended position to the retracted position.

5. The electronic device recited in claim 1, wherein the switching means comprises at least one of a solid state switch, a capacitance proximity switch, a light activated switch and a dark activated switch.

6. The electronic device recited in claim 1, wherein the function comprises switching on and off a power source.

7. The electronic device recited in claim 6, wherein the power source provides power to a Liquid Crystal Display (“LCD”) panel.

8. The electronic device recited in claim 1, wherein the function comprises activating a power save mode of the electronic device.

9. An electronic device comprising:
a display having at least one connecting member;
a body having a raised portion for rotatably supporting the display, the raised potion having at least one recess provided therein adapted for receiving the at least one connecting member; and
switching means for performing a function, the switching means provided within the raised portion such that the function is performed by moving the display between opened and closed positions.

10. The electronic device recited in claim 9, wherein the switching means comprises a mechanical switch.

11. The electronic device recited in claim 10, wherein the switching means further comprises a detecting member movable between a retracted position within the raised portion and an extended position projecting outside of the raised portion into the at least one recess, the detecting member movable by the at least one connecting member for operating the mechanical switch.

12. The electronic device recited in claim 11, wherein the switching means further comprises:
a supporting body for supporting the detecting member, the supporting body having a side surface; and
a spring member having a first end fixed to the supporting body and a second end elastically movable between a first position contacting the side surface of the supporting body and a second position contacting the mechanical switch, the second end of the spring member being moved from the first position to the second position by the detecting member when the detecting member is moved by the at least one connecting member from the extended position to the retracted position.

13. An electronic device comprising:
a display having at least one connecting member;
a body having a raised portion for rotatably supporting the display, the raised portion including at least one recess adapted to receive the connecting member;
a switch within the raised portion for performing a function; and
a detecting member movable between a retracted position within the raised portion and an extended position projecting outside of the raised portion such that the detecting member operates the switch.

14. The electronic device recited in claim 13, wherein the detecting member is movable by rotating the display between opened and closed positions.

15. The electronic device recited in claim 14, wherein the raised portion includes a front surface and a side surface.

16. The electronic device recited in claim 15, wherein when the detecting member is in the extended position, the detecting member projects outside of the side surface of the raised portion and into the at least one recess.

17. The electronic device recited in claim 16, wherein the detecting member is moved by the at least one connecting member.

18. The electronic device recited in claim 15, wherein when the detecting member is in the extended position, the detecting member projects outside of the front surface of the raised portion.

19. The electronic device recited in claim 18, wherein the detecting member is moved by a portion of the display.

20. The electronic device recited in claim 19, wherein the portion of the display is a back edge of the display.

21. In an electronic device, a method for operating a switch to perform a function, comprising:
providing a display;
providing a body having a raised portion for rotatably supporting the display; and
providing switching means for performing the function, the switching means provided within the raised portion such that the function is performed by moving the display between opened and closed positions.

22. The method recited in claim 21, wherein the switching means comprises a mechanical switch.

23. The method recited in claim 22, wherein the switching means further comprises a detecting member movable between a retracted position within the raised portion and an extended position projecting outside of the raised portion, the detecting member movable for operating the mechanical switch.

24. The method recited in claim 23, wherein the switching means further comprises:
a supporting body for supporting the detecting member, the supporting body having a side surface; and
a spring member having a first end fixed to the supporting body and a second end elastically movable between a first position contacting the side surface of the supporting body and a second position contacting the mechanical switch, the second end of the spring member being moved from the first position to the second position by the detecting member when the detecting member is moved from the extended position to the retracted position.

25. The method recited in claim 21, wherein the switching means comprises at least one of a solid state switch, a capacitance proximity switch, a light activated switch and a dark activated switch.

26. The method recited in claim 21, wherein the function comprises switching on and off a power source.

27. The method recited in claim 26, wherein the power source provides power to a LCD panel.

28. The method recited in claim 21, wherein the function comprises activating a power save mode of the electronic device.
